(19) United States
(12) Patent Application Publication
(10) Pub. No.: US 2008/0246005 A1
(43) Pub. Date: Oct. 9, 2008

(54) Phosphor for blue-light led, blue-light led using same

(76) Inventors: Soshchin Naum, Changhua City (TW); Wei-Hung Lo, Taipei City (TW); Chi-Ruei Tsai, Taipei City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 12/078,709

(22) Filed: Apr. 3, 2008

(30) Foreign Application Priority Data
Apr. 4, 2007 (TW) 096111995

(51) Int. Cl. C09K 11/77

(52) U.S. Cl. 252/301.4 R

(57) ABSTRACT

A phosphor for blue-light LEDs formed by different solid solutions of (ΣLn)₃Al₅O₁₂ and Me^{II}₃Me^{III}₂Si₃O₁₂ with a ratio of (1-x):x having a stoichiometry of (ΣLn)₃₋ₓMe^{II}₃ₓMe^{III}₂ₓAl₅₋ₓSi₃ₓO₁₂, in which Ln=Y and/or Gd and/or Lu and/or Ce and/or Yb and/or Pr and/or Sm, Me^{II}=Mg and/or Ca and/or Sr and/or Ba Me^{III}=In and/or Ga and/or Sc, in which 0.0001≦x≦0.2. The specific composition of the phosphor has a color coordinate of x≧0.42 and the total coordination number of Σ(x+y)≧0.92. The radiation of the phosphor is in the range of λ=500˜750 nm and the position of the maximum spectrum changes from λ=520˜585 nm. The light-emitting diodes made from this phosphor can emit very bright, warm white light with light intensity reaching 400˜600 cd, total flux F>420 lm, and light efficiency over 100 lm/W.

### BACKGROUND OF THE INVENTION

1. Field of the Invention

The present invention relates to optical technology and more particularly, to an orange phosphor and white-light LEDs using such phosphor. This newly developed research started from the literature issued by S. Nakamura, Japan, in 1997 (see S. Nakamura, Blue laser, Springer Verlag, Berlin, 1997). This literature has made substantial contribution to the creation of blue-violet laser and white-light LED.

2. Description of the Related Art

After one-decade development in industry, people have not only equipped with sufficient knowledge about white-light LED-related research but also established a materialogy for creating new light-emitting materials. One of the known patents (see Au 4065002, Y. Schimizu et. al. 27 Jun. 2002) described InGaN-based blue-light LED, which indicates the necessity of Y₃Al₅O₁₂:Ce phosphor. The reference object related to this phosphor can be assembled with a blue-light LED only when the blue-light LED has a high color temperature T>8000 k. To correct this drawback, researchers proposed the application of a second phosphor to the lighting conversion layer. This second phosphor is based on CaS:Eu⁺² of red radiation spectrum. CaS:Eu⁺² based phosphor has certain perfection, however the chemical instability feature of this phosphor does not allow the phosphor for making stable LEDs.

In certain chromaticity-modified Y₃Al₅O₁₂:Ce garnet phosphors, the composition has Gd⁺³ or Tb⁺³ added thereto. These ions alter the lighting spectrum of the phosphors. When Gd⁺³ is added to about 25% in the material, the maximum value of spectrum of the composition of (Y₁₋ₓGdₓCe_{y})₃Al₅O₁₂ is shifted to λ=545˜560 nm (see Y. Schimizu et. al., AU 6614179, 2 Sep. 2003). The invention uses this phosphor as the prime model. Although many known phosphor compositions have been intensively used in different fields, they still have substantial drawbacks: 1. They can only offer white radiation of chromatic coordinate close to daylight; 2. They have low thermal stability when the heterojunction and the phosphor distributed on its surface are overheating; 3. When there is a big amount of Gd⁺³ in the phosphor composition, the photoluminescent band excited is λ=450˜470 nm, therefore radiation spectrum of the semiconductor heterojunction must be strickly in conformity with the excited spectrum of the phosphor, or the brightness of the device will drops drastically.

### SUMMARY OF THE INVENTION

The present invention has been accomplished to provide a phosphor for white-light LEDs that effectively eliminates the drawbacks of the prior art phosphors and the drawbacks of white-light LEDs prepared from the prior art phosphors. It is therefore the main object of the present invention to provide an orange phosphor for white-light LEDs, which expands the radiation spectrum to the orange subband.

It is another object of the present invention to provide a phosphor for white-light LEDs, which maintains the quantum efficiency when the electromagnetic wave spectrum shifts toward warm tone.

It is still another object of the present invention to provide an orange phosphor for white-light LEDs, which increases the thermal stability of the lighting when the temperature range is over 100° C.

It is still another object of the present invention to provide an orange phosphor for white-light LEDs, which has a high color transmission coefficient, i.e. rendering index Ra, can be obtained.

To achieve these and other objects of the present invention, the orange phosphor of the present invention is to be used in the metal oxide and non-metal oxide substrate of an InGaN heterojunction coating and excitable by cerium. The orange phosphor is a solid solution formed of a first compound having the chemical formula of (1-x)(ΣLn)₃Al₅O₁₂ and a second compound of xMe^{II}₃ Me^{III}₂Si₃O₁₂. The solid solution formed under this condition has a cubic system and 1a3d phase.

Further, in the first compound and the second compound, Ln=Y and/or Gd and/or Lu and/or Ce and/or Yb and/or Pr and/or Sm, Me^{II}=Mg and/or Ca and/or Sr and/or Ba Me^{III}=In and/or Ga and/or Sc.

Further, in the first compound, x=0.001˜0.15.

Further, when Me^{II}=Mg, the lattice parameter is a≦12.0 Å; when Me^{II}≠Mg, the lattice parameter is a>12.0 Å.

Further, the phosphor is excitable by at least two exciting agents, based on Ln=Ce and/or Yb and/or Pr and/or Sm and, in the radiation ranging from 500 to 720 nm, the maximum radiation spectrum being located at the spectrum subband, starting from λ=520˜590 nm.

Further, the phosphor is joined to an InGaN-based semiconductor heterojunction that offers a blue-light shortwave radiation and has the surface thereof covered by the phosphor. The phosphor is evenly distributed in the volume of a polymer coating on the surface of the InGaN-based semiconductor heterojunction.

Further, the phosphor has a positive-ion lattice formed therein, said positive-ion lattice being based on ΣLn=Y and/or Gd and/or Lu of which the solubility in said phosphor is [Y]=3y, [Gd]=3z, and [Ln]=3p and consequently, Σ3y+3z+3p=3-x, wherein 0.6≦y≦0.79 and 0.01≦z≦0.05.

Further, the phosphor comprises an exiting agent based on Ce and/or Yb and/or Pr and/or Sm. The solubility of the exciting agent in the matrix of the phosphor is 0.005≦[Ce]≦0.1, 0.0001≦[Yb]≦0.001, 0.0001≦[Pr]≦0.01, and 0.0001≦[Sm]≦0.01. The maximum half-width of the radiation spectrum of the phosphor excited by the exiting agent ranges from 112˜125 nm.

Further, the maximum half-width of the radiation spectrum starts from Δλ_{0.5}=112 nm when a pair of exciting agent, Ce+Yb, Ce+Pr, or Yb+Pr, is added, and the half width reaches Δλ=125 nm when all the sixth exciting agents of Ce+Yb, Ce+Pr, and Yb+Pr are added.

Further, when the stoichiometric coefficient x is 0.005≦x≦0.01, the light-emitting color coordinate value is Σ(x+y)≧0.8; when the stoichiometric coefficient x is 0.01≦x≦0.05, the light-emitting color coordinate value is Σ(x+y)>0.90.

Further, the phosphor has the specific composition of Y_{2.75}Gd_{0.15}Ce_{0.019}Yb_{0.001}Mg_{0.03}Si_{0.03} and the radiation occurs in the orange spectrum of λ=575 nm with the maximum radiation spectrum λ=568 nm and the main wavelength λ=575 nm and the radiation color coordinate of x=0.41 and y=0.48.

Further, the phosphor has the specific composition of Y_{2.96}Ce_{0.029}Pr_{0.001}Mg_{0.12}Si_{0.12}Sc_{0.04}O₁₂ and the radiation occurs in the orange spectrum of λ=574 nm with the main wavelength λ=580 nm and the radiation color coordinate of x=0.4 and y=0.51.

Further, the phosphor has the specific composition of Y_{2.6}Gd_{0.02}Lu_{0.06}Ce_{0.019}Dy_{0.001}Ca_{0.3} and the radiation occurs in the orange spectrum of λ=576 nm with the main wavelength λ=582 nm and the radiation color coordinate of x=0.445 and y=0.538.

Further, the phosphor has oval-shaped particles. The oval-shaped particles have a tangent diameter greater than 10˜20 times of the maximum wavelength of radiation spectrum, linear diameter in dispersion relation d₅₀=4±0.5 μm, mean diameter d_{cp}=6±0.5 μm, and diameter d₉₇≦18 μm.

To achieve these and other objects of the present invention, the white-light LED is based on an InGaN semiconductor heterojunction that has coated thereon a polymer coating. The polymer coating has contained therein a phosphor prepared according to the present invention. The polymer coating is coated on the surface of the main radiation plane and facets of the InGaN semiconductor heterojunction, and the concentration of the phosphor in the polymer coating is 3˜30% by volume.

Further, the thickness of the polymer coating is 60˜120 μm.

Further, the polymer used in the polymer coating is a thermosetting polymer containing epoxy group —C—O—C— or siloxane group —Si—O—C— with molecular mass of 10000˜25000 carbon units and 200˜500 of degree of polymerization.

Further, a lens cap based on polycarbonate for outputting light, a conical refractor, and a polymer filled in the space between photopolymerization films, in which the refractive index of the polymer coating is 1.45<n≦1.58, are disposed.

Further, when power is supplied to the blue-light LED, the blue-light LED provides a warm white radiation with color temperature T≦4500K, viewing angle 2θ=15°, and light intensity 400 cd; for 1 W power, the lighting efficiency is over 100 lm/W and for 7 W, the lighting efficiency is over 60 lm/W.

### BRIEF DESCRIPTION OF THE DRAWINGS

FIG. 1 is a spectroradiometric analysis report listing the radiation materials with maximum spectrum λₚ=542 nm and the related colorimetric characteristic curves according to the present invention.

FIG. 2 is a spectroradiometric analysis report listing the radiation materials with maximum spectrum λₚ=550 nm and the related colorimetric characteristic curves according to the present invention according to the present invention.

FIG. 3 is a spectroradiometric analysis report listing the radiation materials with maximum spectrum λₚ=560 nm and the related colorimetric characteristic curves according to the present invention.

FIG. 4 is a spectroradiometric analysis report listing the radiation materials with maximum spectrum λₚ=567 nm and the related colorimetric characteristic curves according to the present invention.

FIG. 5 is a spectroradiometric analysis report listing the radiation materials with maximum spectrum λₚ=569 nm and the related colorimetric characteristic curves according to the present invention.

FIG. 6 is a spectroradiometric analysis report listing the radiation materials with maximum spectrum λₚ=609 nm according to the present invention.

### DETAILED DESCRIPTION OF THE PREFERRED EMBODIMENT

At first, the main object of the present invention is to eliminate the drawbacks of the aforesaid prior art white-light semiconductor light sources and phosphors. To achieve this object, the orange phosphor according to the present invention is embodied as follows: proposing metal oxide and non-metal oxide phosphor excitable by cerium, characterized by that the aforesaid phosphor is solid solution of two compounds, in which the first compound has the chemical formula of (1-x)(ΣLn)₃Al₅O₁₂ and the second compound has the chemical formula of xMe^{II}₃Me^{III}₂Si₃O₁₂. Under this condition, Ln=Y and/or Gd and/or Lu and/or Ce and/or Yb and/or Pr and/or Sm, Me^{II}=Mg and/or Ca and/or Sr and/or Ba Me^{III}=In and/or Ga and/or Sc, 0.0001≦x≦0.2. The solid solution has a cubic crystal system and 1a3d structure. Further, when Me^{II}=Mg, the lattice parameter is a≦12.0 Å; when Me^{II}≠Mg, the lattice parameter is a>12.0 Å;

wherein, the phosphor is excitable by at least two exciting agents, based on Ln=Ce and/or Yb and/or Pr and/or Sm and, in the radiation ranging from 500 to 700 nm, the maximum radiation spectrum being located at the spectrum subband, starting from λ=520˜590 nm;

wherein, the phosphor is joined to an InGaN-based semiconductor heterojunction that offers a blue-light shortwave radiation and has the surface thereof covered by the phosphor. The phosphor is evenly distributed in the volume of a polymer coating on the surface of the InGaN-based semiconductor heterojunction;

wherein, the phosphor has formed therein a positive-ion lattice that is based on ΣLn=Y and/or Gd and/or Lu of which the solubility in the phosphor is [Y]=3y, [Gd]=3z, and [Ln]=3p and consequently, Σ3y+3z+3p=3−x, wherein 0.6≦y≦0.79 and 0.01≦z≦0.05;

wherein, the phosphor comprises an exiting agent based on Ce and/or Yb and/or Pr and/or Sm. The solubility of the exciting agent in the matrix of the phosphor is 0.005≦[Ce]≦0.1, 0.0001≦[Yb]≦0.001, 0.0001≦[Pr]≦0.01, and 0.0001≦[Sm]≦0.01. The maximum half-width of the radiation spectrum of the phosphor excited by the exiting agent ranges from 112˜125 nm;

wherein, the maximum half-width of the radiation spectrum starts from Δλ_{0.5}=112 nm when a pair of exciting agent, Ce+Yb, Ce+Pr, or Yb+Pr, is added, and the half width reaches Δλ=125 nm when all the sixth exciting agents of Ce+Yb, Ce+Pr, and Yb+Pr are added;

wherein, when the stoichiometric coefficient x is 0.005≦x≦0.01, the light-emitting color coordinate value is Σ(x+y)≧0.8; when the stoichiometric coefficient x is 0.01≦x≦0.05, the light-emitting color coordinate value is Σ(x+y)>0.90;

wherein, the phosphor has the specific composition of Y_{2.75}Gd_{0.15}Ce_{0.019}Yb_{0.001}Mg_{0.03}Si_{0.03} and the radiation occurs in the orange spectrum of λ=575 nm with the maximum radiation spectrum λ=568 nm and the main wavelength λ=575 nm and the radiation color coordinate of x=0.41 and y=0.48;

wherein, the phosphor has the specific composition of Y_{2.96}Ce_{0.029}Pr_{0.001}Mg_{0.12}Si_{0.12}Sc_{0.04}O₁₂ and the radiation occurs in the orange spectrum of λ=574 nm with the main wavelength λ=580 nm and the radiation color coordinate of x=0.4 and y=0.51;

wherein, the phosphor has the specific composition of Y_{2.6}Gd_{0.02}Lu_{0.06}Ce_{0.01}Dy_{0.001}Ca_{0.3} and the radiation occurs in the orange spectrum of λ=576 nm with the main wavelength λ=582 nm and the radiation color coordinate of x=0.445 and y=0.538; and

wherein, the phosphor has oval-shaped particles. The oval-shaped particles have a tangent diameter greater than 10˜20 times of the maximum wavelength of radiation spectrum, linear diameter in dispersion relation d₅₀=4±0.5 μm, mean diameter d_{cp}=6±0.5 μm, and diameter d₉₇≦18 μm.

The physical-chemical properties of the phosphor prepared according to the present invention will be described hereinafter in details. At first, it is to be understood that all the YAG type phosphors are substitutional solid solutions. There is about 25% Gd₃Al₅O₁₂ solved in these Y₃Al₅O₁₂-based materials. In these materials, a Ce⁺³ luminescence center is established, Ce⁺³ partially substitute for Y⁺³ in the phosphor substrate. These two processes are recorded by formula to be (Y_{1-x-y}GdₓCe_{y})₃Al₅O₁₂. However, there are elements of same valance in this solid solution formula that is because Y⁺³, Gd⁺³, Ce⁺³ have the same valence. The substituted Y⁺³ has an ionic radius close to the other ions, i.e., the ionic radius of Y⁺³ is 0.97 Å, the ionic radius of Gd⁺³ is 0.95 Å, the ionic radius of Ce⁺³ is 1.04 Å. Same valence and similar geometric size allow creation of uniform solid solutions. However, in the observed YAG system, the solubility range of the substitutional ions in these solid solutions is limited. The solubility of Gd⁺³, as stated above, is regarded to be 25˜30% atomic fraction, however with respect to Ce⁺³, it does not exceed by 5˜6%. In the YAG system, the so-called heterogenous solid solution is proposed to substitute for a uniform solid solution. A heterogenous solid solution is a combination of compounds of different formulas. These compounds have different valences and basic ions, and are composed at a predetermined ratio. The particulars of the phosphor of the present invention will be pointed out hereinafter: Phosphor-related literatures usually merely mention the stachiometric formula of YAG-Y₃Al₅O₁₂ or (Y₂O₃)_{1.5}(Al₂O₃)_{2.5}. However, to solid, accurately maintaining the stoichiometry, i.e. the specific value between the oxides of Y₂O₃ and Al₂O₃ to be 1.5:2.5=0.6, is a rare phenomena and can be excluded from the rule. In US 20050088077 A1, we indicated this asymmetry and disclosed an accurate form: (Y_{1-x-y-z-q-p}GdₓDy_{y}Yb_{z}Er_{q}Ceₚ)_{α}(Alₗ₋ₙ₋ₘ₋ₖGaₙScₘInₖ)_{β}O₁₂, in which α=2.97˜3.02, β=4.98˜5.02. From this record, it is clear that the specific value of the positive ion and negative ion lattice-based oxide is not equal to 0.6 but varying over a wide range. When considering all possible stoichiometric formulas, the following complications of this problem must be pointed out, these formulas include garget compounds.

The following catalogue indicates known garnet compounds. This catalogue refers to YAG (Yttrium Aluminum Garnet), more specifically, rare earth dopped aluminum garnet.

I The first is (ΣLn)₃(Al,Ga)₅O₁₂, in which ΣLn is known as Σ(Y+Gd+Lu+Ce).

II The second is the “non-stoichiometric rare earth-yttrium garnet” (Y_{1-x-y-z-q-p}GdₓDy_{y}Yb_{z}Er_{q}Ceₚ)_{α}(Alₗ₋ₙ₋ₘ₋ₖGaₙScₘInₖ)_{β}O₁₂. in which α=2.97˜3.02, β=4.98˜5.02. This formula points out the stoichiometric conception of relativity regarding “high temperature oxygen-contained compound”.

III The third is based on the original of human culture of the formula of natural garnet: Me^{II}₃Me^{III}₂Me^{IV}₃O₁₂. In this formula, when Me^{II} is Mg⁺² or Ca⁺², Me^{III} is Al⁺³, and Me^{IV} is Si⁺⁴, thus we can get the famous natural mine of “Mayenite”. When the material is added with Fe⁺³ or Mn⁺², it shows a reddish tone. Me^{II} can be Ca⁺² or Sr⁺².

IV The fourth is a variant of synthesized garnet structure ((ΣLn)₃(Me^{II}Me^{IV})₅O₁₂). Equal amount of Mg⁺² and Si⁺⁴ atoms replace by Al⁺³ in this artificial mineral, which is characterized by its smaller gate parameter (d≦12 Å) when compared with the standard value.

V The fifth garnet compound is Me^{I}₂Me^{II}₂Ln^{III}Me^{V}₃O₁₂, which evidently comprises 20 atoms in the formula. They are from five different groups of the periodic table, including I and V groups. These two groups do not appear in the four structures described above. The combination of elements for the present garnet structure is rather unique, comprising Li and/or Na, Mg and/or Ca, rare earth elements (Ln^{III}), and V⁺⁵ and/or Nb⁺⁵ and/or Ta⁺⁵ ions in the VB group.

VI In the sixth formula, the garnet compound has added thereto elements from I, VI, and VIII groups to form Me^{I}₃Te^{VI}FeO₁₂, which has a fixed gate parameter of d≈12.1 Å.

VII In other energy level, the crystal structure Me^{II}₃ Me^{VI}₂Me^{II}ₐ₃O₁₂ is created, in which Me^{II}=Mg⁺², Ca⁺², Sr⁺², resulting in the formation of tellurous garnet. In the garnet structure, the positions of Me^{II}ₐ in the coordination number Ka=4 are replaced by Zn⁺² to form a stoichiometric formula, Mg₃Te₂Zn₃O₁₂. In this situation, it cannot be argued that the elements constituted have similarity; the elements, unlike Al or Ga, are very different from Zn⁺².

VIII The formula can be expressed as Me^{V}₃ Me^{VI}₂Me^{I}₃O₁₂. When elements with identical valences (Me^{I}=Li, Me^{VI}=Te⁺⁶, and Me^{V}=Bi⁺³) are added, the unusual garnet structure, Li₃Bi₃Te₂O₁₂, will be obtained.

IX The ninth formula is Me^{II}₁Ln^{III}₂Me^{V}₂Me^{II}ₐ₃O₁₂. When rare earth elements are added, Me^{II}=Ca⁺², Ln^{III}=Y, Me^{V}=Sb, and Me^{II}ₐ=Zn, the compound CaY₂Sb₂Zn₃O₁₂, similar to certain natural garnets, can be obtained.

X In the formula Ln^{III}₃Te^{VI}₂Li₃O₁₂, the rare earth element Ln^{III} added can be found and the smaller Te^{VI} has a coordination number of Ka=6 with Ln^{III} having Ka=8.

XI When the artificial structure Ln^{III}₃(Me^{VIII},Me^{IV})₅O₁₂ added with elements with identical molecules, i.e., Me^{VIII}=Co⁺² and Me^{IV}=Ge, a stoichiometric formula, Σ(Ln)₃Co_{2.5}Ge_{2.5}O₁₂, will be obtained.

XII The twelfth formula is Me^{I}₁Me^{II}₂Me^{V}₂O₁₂. When arsenic compound is included in the formula, sufficient low melting temperature, T_{melting}≈800° C., will be seen. Some authors consider simple garnet structure can have the feature of “relayed transmission” (i.e. double), and thus 40 atoms are included in the structure.

XIII A variant based on the thirteen structure Ln^{III}₆Me^{II}₄Me^{II}₁Me^{IV}₅O₂₄ can lead to Ln₆Mg₄Ca₁Si₅O₂₄.

XIV The present fourteenth formula Ln₆(Me^{II}Me^{IV})₁₀O₂₄ may be considered as a “copy” of the IV formula. When conventional replacement elements are added, Ln=Y, Me^{II}=Ca⁺², and Me^{IV}=Si⁺⁴, the formula becomes Y₆Mg₅Si₅O₂₄.

XV Final formula in the catalogue is (ΣLn)₃Me^{VI}₂Me^{I}₃O₁₂. When synthesized, the formula of the compound becomes Nd₃W₂Li₃O₁₂, whose similarity with YAG is extremely unnoticeable.

It is clear that the catalogue described does not include the formula with O⁻² being replaced by element of similar size, F⁻¹ or N⁻³. However, the present incomplete catalogue still characterizes the structure garnet compound: 1. They can be formed by elements from all groups (not only III group, just like YAG). 2. When elements contained in a unit cell are equal, non-stoichiometric garnet will be resulted. 3. In the sub-system of anodic ions, the change of different coordination numbers Kₐ=6 and 4 can be investigated thoroughly. All these compounds with identical structure have different properties. From the data of melting point, for example, their melting points are very different: Y₃Al₅O₁₂, T<2400° C.; Na₃Te₂Ga₂O₁₂, T≈700° C.; CaGd₃Sb₂En₃O₁₂, T=1250° C.; Tb₃Al₅O₁₂T=2200° C. and so on.

Undoubtedly, even though the exciting agent is same, Ce⁺³ for example, the light-emitting property of the garnet structures will still be different. Also, the garnet-like compounds formed by IIA elements are easily excitable by exciting agents, such as Eu⁺², Bi⁺³, Sm⁺², and Pr⁺³.

One conclusion can be obtained from the aforementioned formulas; under a legitimate formula, a compound with merely a different chemical composition cannot be authorized. Therefore, a generalized explanation of terminology for garnet-like compounds is offered to clarify what garnets with similar structure can form heterogeneous solid solutions.

During the development of the present, it is found that the optimum condition can be obtained when two garnet-like structures, Σ(Ln)₃Al₅O₁₂ and Me^{II}₃Me^{III}₂Si₃O₁₂, are combined together.

When [Y]ₓ and [Al]ₙ are replaced by other ions, the minimum electric charge compensation is required. The ions are based on Me^{II}=Mg⁺² and/or Ca⁺² and/or Sr⁺² and/or Ba and/or Si^{IV}. In reality, the ionic diameters of Y⁺³ and Ca⁺² are very close: τ_{Y}=0.97 Å and τ_{Ca}=1.04 Å. When Si⁺⁴ is compared with Al⁺³, the radius of Si⁺⁴ is smaller, τ_{Si}=0.48 Å and τ_{Al}=0.57 Å. Therefore, the replacement solid solution can be easily formed. When the phosphor is being synthesized, the components added have high enough melting points and do not experience phase transformation. If the melting point of Y₂O₃ is T_{melting}=2400° C., that for the replacement ions MgO is T_{melting}=2800° C. and CaO is T_{melting}=2600° C. Also, the melting point for Al₂O₃ is T_{melting}=2400° C. and that for the corresponding Sc₂O₃ is T_{melting}=2700° C. According to the data of the present invention, the ratio of YAG (isogenous) isomorphous volume to garnet (Me^{II}₃Me^{III}₂Me^{IV}₃O₁₂) is x=0.2 in molar fraction, which set the upper limit of X in the stoichiometric formula, Σ(Ln)₃₋ₓMe^{II}ₓMe^{III}ₓAl₅₋₂ₓSiₓO₁₂, of heterogenous solid solution.

The limit is “x=0.2” as suggested in the present invention. It should be noted that the patent application of the present invention does not disclose the solubility of the garnet (ΣLn)₃(Al,Ga)₅O₁₂ in the garnet structure Me^{II}₃Me^{III}₂Me^{IV}₃O₁₂. With the further development in producing phosphor, the issue of solubility will be investigated furthermore.

As described earlier, the solid solution with garnet structure according to the present invention has a gate parameter of a≦12 Å, which is related to the reduced size of ions series constituting the solid solution; the size of Si⁺⁴ is smaller than that of Al⁺³, for example. Mg⁺², replacing partial Al⁺³ and Y⁺³, has a rather small radius: τ_{Mg}=0.56 Å. The contraction of lattice will result in crucial consequences, which are described as follows: 1. The reduced lattice parameter of garnet will increase its weight density; 2. The substation of Si⁺⁴ with higher-charge Al⁺³ will increase the electrostatic field inside the crystal; 3. Two-valence ions, Mg⁺², Ca⁺², or Sr⁺², substituting Y⁺³ will reduce the electrostatic stress field inside the crystal and, in the mean time, increase the electrostatic field stress gradient in the solid solution lattice of garnet.

The change of electric field in the garnet solid solution lattice can substantially affect the properties of radiated (excited) ions. The increased electrostatic field and extended electric field stress can enhance the emitting rate of the main excited ion Ce⁺³ in the garnet lattice. Also, the Ce⁺³ radiation spectrum parameter will also be changed. The change may mainly be related to the shifting of the maximum spectrum to short-wave or long-wave spectrum zone. In the mean time, the half-wave width of the radiation spectrum curve becomes narrower or wider.

Phosphor suitable for these behaviors is characterized by that it can be excited by at least two exciting agents, based on Ln=Ce and/or Yb and/or Pr and/or Sm and, in the radiation ranging from 500 to 720 nm, the maximum radiation spectrum is located at the spectrum subband, starting from λ=520˜590 nm.

In developing the phosphor of the present invention, the lattice is preferably constituted by two excited ions, i.e. Ce⁺³ and Pr⁺³, Ce⁺³ and Yb⁺³, or Ce⁺³ and Sm⁺³. These ions guarantee the radiation spectrum of the phosphor lies in the range 500˜740 nm, which is a considerably large width in the visible radiation range of phosphor. Also, the phosphor provided has its maximum radiation spectrum shifting from the green spectrum range, λ=520˜530 nm, to orange spectrum range, λ=580˜585 nm. The literature so far has no information about the shifting of the maximum spectrum for the light-emitting garnet. The result of shifting is ascertained with the following illustrations.

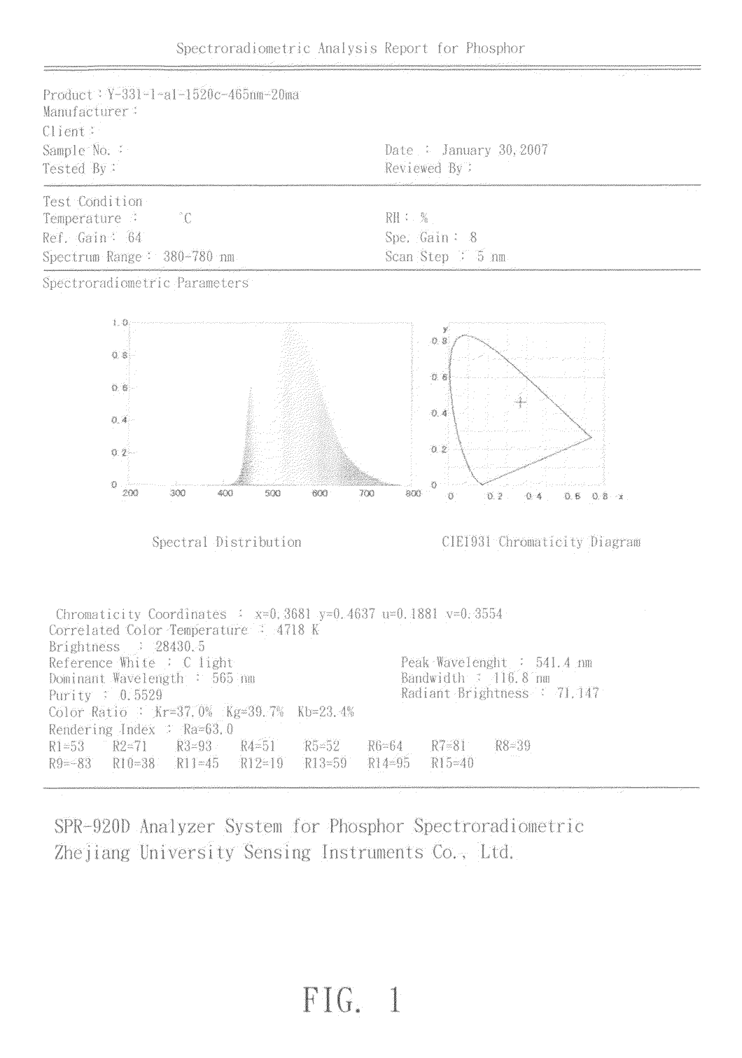

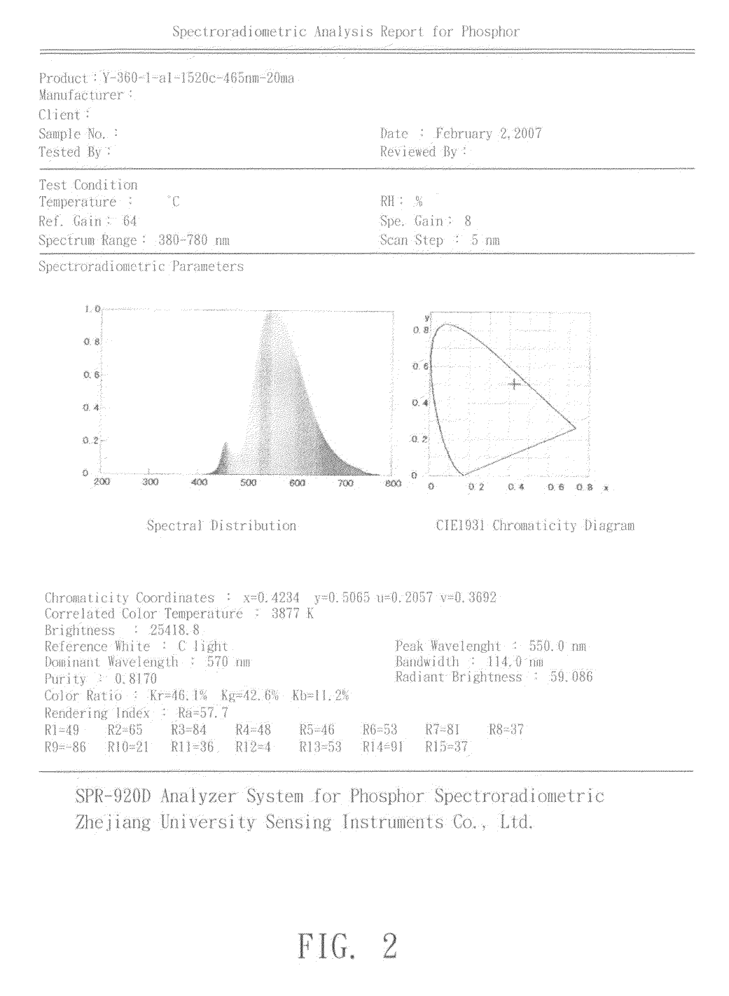

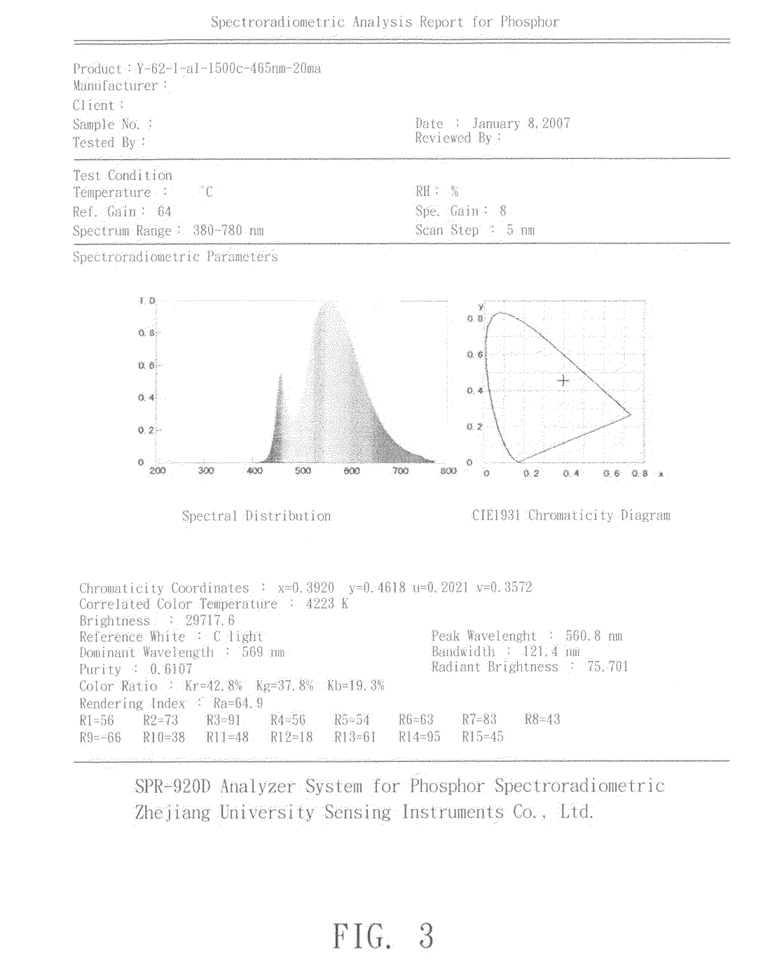

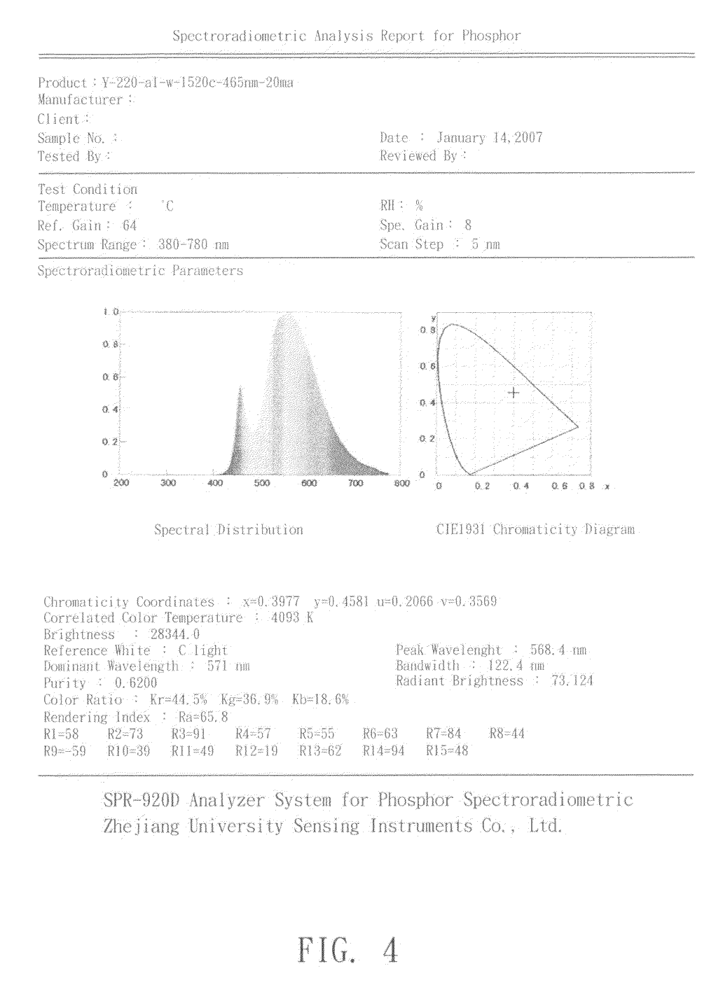

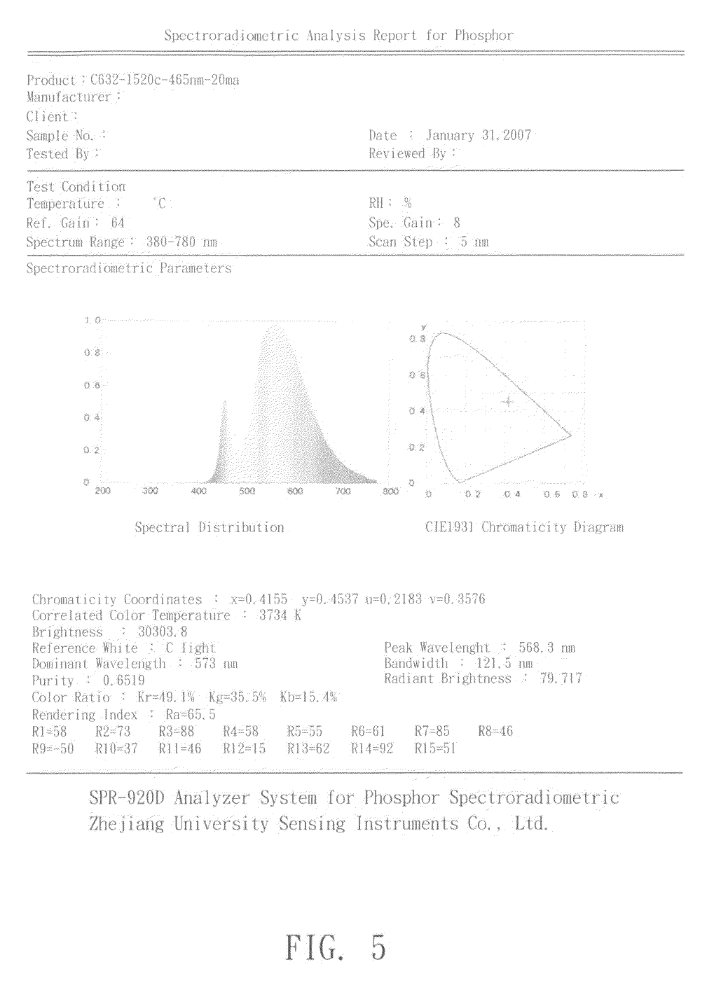

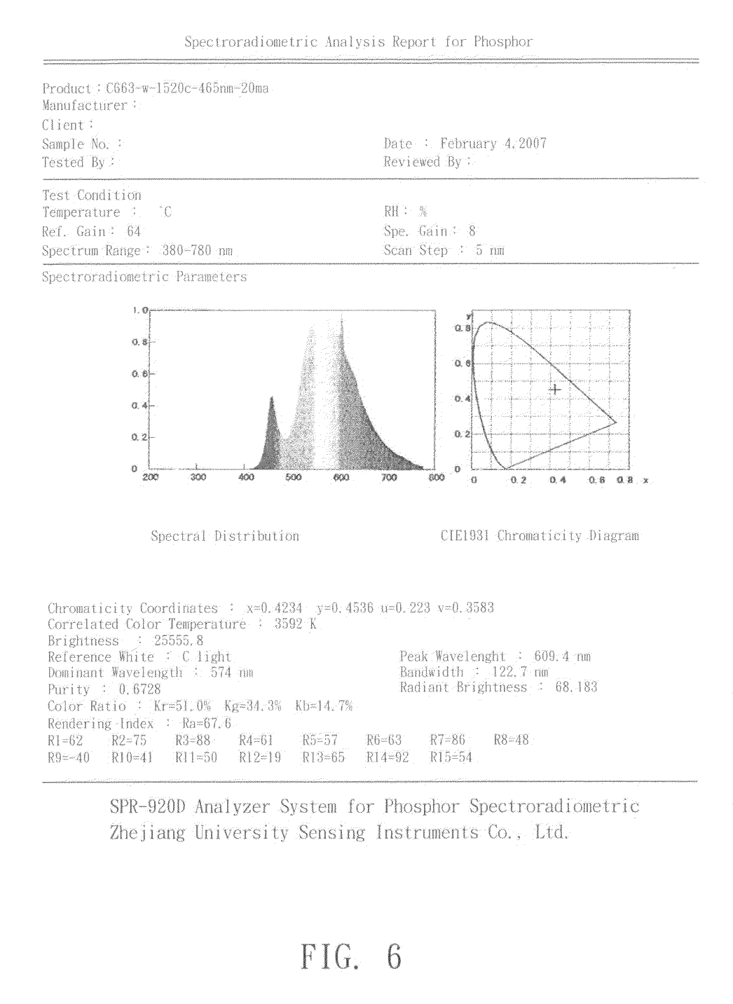

FIG. 1 lists the radiation materials with maximum spectrum λₚ=542 nm and all their colorimetric characteristic curves. FIG. 2 lists the radiation materials with maximum spectrum λₚ=550 nm and all their colorimetric characteristic curves. FIG. 3 lists the radiation materials with maximum spectrum λₚ=560 nm and all their colorimetric characteristic curves. FIG. 4 lists the radiation materials with maximum spectrum λₚ=567 nm and all their colorimetric characteristic curves. FIG. 5 lists the radiation materials with maximum spectrum λₚ=569 nm and all their colorimetric characteristic curves. FIG. 6 lists the radiation materials with maximum spectrum λₚ=609 nm (the value with respect to the phosphor has not been published elsewhere). From the work of G Blasse [Blasse G Luminescence material, Amsterdam Springer, 1994], the present invention has found that the garnet of Gd₃Al₅O₁₂:Ce may possess the maximum spectrum of λₚ=580 nm. With respect to the accuracy, the maximum λₚ=609 nm identified here is the result of phosphor. However, the maximum spectrum induced by the addition of Pr⁺³ is more effective and higher than that by including Ce⁺³.

The present invention also points out that the creation of the heterogenous solid solution can change the light-emitting spectrum of the phosphor as well as its exciting spectrum. In fact, the Ce⁺³ is mainly related to the exciting band and charge transfer band Ce⁺³—O⁻². To be precise, it is the effects of electron pair of Ce⁺³ on the d-f electron pair of oxygen. The stable constitution can only change its energy though the following methods: 1. Al—Ga solid solution is created in the negative-ion lattice of phosphor; i.e., the stoichiometric formula is reduced to Y₃(Al,Ga)₅O₁₂:Ce. In this situation, the result is that the matrix lattice parameter increases, internal electrostatic field decreases, and the charge-transfer band Ce⁺³—O⁻² experiences a short-wave displacement. 2. All or 80% of Y⁺³ ions are replaced by Tb⁺³ in the phosphor matrix. Since the radius of the Tb⁺³ ions is smaller than that of Y⁺³, it is even more suitable in increasing the lattice stress field. The charge-transfer band Ce⁺³—O⁻² also experiences a short-wave displacement. The maximum excited spectrum displaces from λ=465 nm to λ=450˜455 nm. 3. Positive-ion lattice is added with Lu⁺³ ions to partially replace about 0.25 (atomic fraction) of basic positive ions Yb⁺³. The Lu⁺³ ion is characterized by its smallest ion radius, τ_{Lu}=0.81 Å. The reduction of the radius of the basic positive ions is accompanied with the displacement of the short wave of excited band to λ₁=440 nm. 4. The substitution by different valences presented in the present invention, Al→Mg_{Al}+Si_{Al}^{o}, also applies to the charge-transfer band. However, λ₁=480 nm has shifted to the long-wave range. 5. In the early approach, partial substitution of Gd⁺³ by Y⁺³, the wavelength limit of the excited spectrum has been ascertained to be λ=475˜485 nm.

The characteristics of employing the phosphor according to the present invention in the mechanisms are described as follows. The negative-ion lattice formed is based on ΣLn=Y and/or Gd and/or Lu; their solubility in the phosphor is [Y]=3y, [Gd]=3z, and [Ln]=3p. Consequently, Σ3y+3z+3p=3−x, wherein 0.6≦y≦0.79 and 0.01≦z≦0.05. It can be concluded from the above discussion that the atomic fraction Y⁺³ is substantially different from other ions, including 0.3 (atomic fraction) of Gd⁺³ to 0.05 (atomic fraction) of Lu⁺³. Since the oxide, Lu₂O₃, added is expensive; the cost of phosphor is substantially raised.

As indicated in FIG. 1, the spectrum of phosphor is a Gauss curve, in which there is certain asymmetry. One parameter of the curve is named as the spectrum curve half-width Δ_{0.5}. For a standard phosphor, Δ_{0.5}≧120 nm, this is a rather large value and there are certain substantial drawbacks, including the reduction of the radiation lumen equivalence Q1. For the standard phosphor, Y₃Al₅O₁₂:Ce, Δ_{0.5}=122 nm Q1=320 lm/W. If the spectrum broadens, the average lumen equivalence reduces to Q1=290 lm/W, or even down to Q1=265 lm/W.

It is confirmed that the framework of the heterogenous solid solution according to the present invention can substantially contract the Gauss curve to Δ_{0.5}=112 nm (please refer to FIG. 2). When the composition of phosphor is added with excited ions, Ce⁺³ or Yb⁺³, the width described can be observed. In such a condition, Q1 can reach a record of Q1=390 lm/W. If a pair of excited ions, Ce⁺³+Pr⁺³ or Ce⁺³+Sm⁺³, according to the present invention are employed, the width can reach Δ_{0.5}=123 nm and then the lumen equivalence can maintain at the level of Q1=340 lm/W.

When all the four exciting agents, Ce⁺³+Yb⁺³+Pr⁺³+Sm⁺³, are added together, the half-width (Δ_{0.5}) can reach 125 nm and the accompanied Q1 is being reduced to 320 lm/W. In the following description, the benefit of increasing half-width will be explained since the color transfer index, named as render index Ra, is increased. The substantial advantages described can be realized in the phosphor according to the present invention. It can be characterized that the excited agent formed is based on the combination Ce and/or Yb and/or Pr and/or Sm, whose solubility in the matrix of the aforementioned material (i.e. phosphor) is 0.005≦[Ce]≦0.1, 0.0001≦[Yb]≦0.001, 0.0001≦[Pr]≦0.01, and 0.0001≦[Sm]≦0.01. When a pair of exciting agents, Ce+Yb, Ce+Pr, or Yb+Pr, is added, the maximum half-width of the radiation spectrum starting from Δλ_{0.5}=112 nm. Further, when all the four exciting agents are added, the half width will reach Δλ=125 mm.

The variation of light-emitting spectrum also determines the change of the colorimetric characteristic curve of the radiation of the phosphor according to the present invention. This is an important issue and is related to the required change of the color coordinates x and y for obtaining white light. Consequently, when the color coordinate of the natural white light is x=0.37˜0.39 and y=0.41˜0.43, it is necessary to achieve x=0.40˜0.41 and y=0.40˜0.44 in order to reproduce warm white light. As described earlier, the aforementioned color coordinate can hardly be achieved in the standard composition of Y₃Al₅O₁₂:Ce. The principle of the heterogenous solid solution structure proposed in the present invention can resolve the complicate problem by employing the variational mode of the stoichiometric coefficient x of the integral solid solution: (1-x)(ΣLn)₃Al₅O₁₂ and xMe^{II}₃Me^{III}₂Si₃O₁₂. Also, the color coordinate may vary in a wide range, x=0.36˜0.42 and y=0.39˜0.52. The unique advantage of the phosphor can be realized in its composition, which is characterized by the sum of the light-emitting coordinate is Σ(x+y)≧0.86 with the stoichiometric coefficient x being 0.005≦x≦0.01; the sum of the light-emitting coordinate described is Σ(x+y)>0.90 with stoichiometric coefficient x being 0.01≦x≦0.05. As indicated in the present invention earlier, the aforementioned color coordinates neither appear in scientific journals nor in known patents.

The phosphor according to the present invention may be manufactured by employing standard solid synthesis or synthesized “sol.”. Standard solid synthesis is more suitable for the manufacturing of a large amount of phosphor. For manufacturing specific experimental sample, a simple method is to meet the specified parameters and in the mean time employ the sol-gel technique. The following example will be demonstrated for explaining the present invention: a certain necessary amount of initial oxide with rare earth elements is soluble in acetic acid; for example,

| | |
|---|---|
| Y₂O₃ | 1.375M(mole); |
| Gd₂O₃ | 0.075M; |
| Ce₂O₃ | 0.005M; |
| Yb₂O₃ | 0.0005M; and |
| Lu₂O₃ | 0.01M |

Gel is added into the mixed solution under preparation under heating condition and sol is based on 4.94 moles of Al(NO₃)₃ precipitating in 10% NH₄OH solution. The gel is based on Al(NO₃)₃ added with 0.03 mole of Si(OC₂H₅)₄ to produce the precipitation of NH₄OH. Mg(OH)₂, 0.03 mole, is added into the sol to produce the precipitation in alkylamine solution from Mg(OH)₂. It is further heated at T=80° C. for 10 hours to dehydrate and heat-treat the gel obtained. The heat treatment is conducted in a weak reducing atmosphere, which is dissociated NH₃ or H₂:N₂ mixture (1:99), or (CO+CO₂) mixture. The heat treatment lasts for 10˜40 hours with the highest temperature reaching 1600° C. The product obtained after the treatment is leached away from alkali content with dilute hot hydrochloric acid. Then particle produces are coated with ZnOxSiO₂ thin film with a thickness less than 50˜70 nm. The thin film can prevent the phosphor from sticking or aggregating together.

The phosphor according to the present invention has these advantages and it is characterized by that the specific composition is Y_{2.96}Ce_{0.029}Pr_{0.001}Mg_{0.12}Si_{0.12}Sc_{0.04}O₁₂ and the radiation occurs in the orange spectrum of λ=574 nm with the main wavelength λ=580 nm and radiation color coordinate of x=0.44 and y=0.51.

The phosphor is unique and contains the Ce⁺³-excited garnet with a color coordinate x=0.44. The phosphor is accurately suitable for the orange radiation of λ=570˜575 nm with its main radiation wavelength being 574˜580 nm. The phosphor can easily reproduce warm white light on blue light InGan heterojunction with color temperature below 400K. The emitted light is very comfortable to human eyes. It also has a high efficiency in achieving over 100 lm/W in a single light-emitting diode. This will be further elaborated in the following section.

The phosphor according to the present invention has a high efficient parameter and it is characterized by that the specific composition is Y_{2.6}Gd_{0.02}Lu_{0.06}Ce_{0.019}Dy_{0.001}Ca_{0.3}Ga_{0.2}Al₄₅Si_{0.3}O₁₂ and the radiation occurs in the orange spectrum of λ=576 nm with the main wavelength λ=582 nm and radiation color coordinate of x=0.445 and y=0.538.

The significance of the phosphor employed does not merely manifest on its own orange light emitting characteristic. Also, the afterglow only lasts a small period of time, 85 ns. The material proposed in the present invention has a very significant meaning in the optical devices for the information transmission in optical fiber. The aforementioned phosphor shows deep orange color, which can effectively absorb the first degree light leakage, resulted from the InGaN semiconductor heterojunction. The deep color of the phosphor is conducive to form a sufficient thickness of light-emitting conversion coating based on phosphor and polymer binding agent. This coating is especially important for the devices; the light-emitting conversion layer is present on the main radiation plane of the heterojunction as well as the edged surfaces. The luminous power from the heterojunction can be raised by 25˜50%.

The phosphor according to the present invention has a substantial advantage and it is characterized by that the material is combined with InGaN semiconductor heterojunction, wherein the heterojunction radiates short-wave light, primarily blue light, and is uniformly covered with aforementioned phosphor, which is uniformly distributed on the polymer coating layer formed on the heterojunction surface.

Another characteristic of the phosphor according to the present invention is the measurement of particle size. Researchers and engineers have not yet reached a consensus for the parameter. In the initial study, it is considered that the optimum participle size of phosphor is around d_{cp}=1˜1.5 μm.

Some consider that since the particles have generated very strong scattering and thus no “hot spot” is expected to be observed in the light-emitting diode. This phenomenon is related to the optical focus of light-emitting diode with very strong blue light spot. The occurrence of blue light spot is due to the direct light transmission of optical transfer on light-emitting diode through the observation screen. In fact, the use of fine and disperse phosphor can prevent hot spot from occurring. However, it is confirmed in later experiment that, compared with large and disperse as well as medium and disperse phosphor, fine and disperse phosphor has a substantially lower output of radiation quantum. On the other hand, large or medium size phosphor cannot provide a dense and strong coating because of uneven surface and poor condensing property.

The present invention pointed out earlier that it is preferably to have oval or oval-like particles, which can guarantee good compactability even under no externally applied pressure. In the present invention, the specific volume parameter is employed to control the property. The specific volume of the phosphor is V=3.6˜3.8 g/cm³, the material according to the present invention is ρ=5.2˜5.4 g/cm³, and the density of single crystal is 68˜73%. These data indicate that the phosphor according to the present invention has a very high compactability and that the technical possibility for phosphor to attain high light intensity is confirmed.

The geometric size of the phosphor according to the present invention should have a certain relationship with the light wavelength of incident radiation. Consequently, larger particles may be able to absorb part of incoming radiation, and small particles are more suitable for increased light loss during the transfer among particles. The phosphor according to the present invention is characterized by that the particles have an oval shape, of which tangent diameter is larger than 10˜20 times of the maximum wavelength of radiation spectrum, and for their dispersion ration, their linear diameter is d₅₀=4±0.5 μm, mean diameter is d_{cp}=6±0.5 μm, and diameter is d₉₇≦18 μm.

The present invention also points out one important characteristic of the medium-disperse phosphor. The particles of the phosphor are pervious to light. The transmission affects the incoming radiation and some absorb the radiation and emit light. The color tone of the phosphor according to the present invention determines the exciting agent required, Ce⁺³, Sm⁺³, Yb⁺³, Pr⁺³, for example, with orange tone in a somewhat yellow. The particles' radiation absorption coefficient on the power level cannot be determined accurately. However, it can be concluded from FIGS. 1 and 6 that the ratio of the maximum radiation for heterojunction (the left peak from λ=463 nm) and the phosphor (the right peak form λ=569 nm) varies between 1:3˜1:5.5. Consequently, the blue light absorption ratio of the phosphor in FIG. 6 is higher than that in FIG. 1 by 1.83 times.

Enhanced absorption is a very important advantage for the phosphor according to the present invention. This advantage can be embodied in the light-emitting diode employing the phosphor. The light-emitting diode is assembled in accordance with conventional setup, with the back surface of the heterojunction being adjacent to the crystal support surface. The front and lateral surfaces of the heterojunction are optically in contact with the polymerized lighting transfer coating, in which the phosphor is distributed. To ensure the uniform white light or warm white light free from distortion and shading, the lighting transfer coating should be uniform on the front and lateral surfaces of the heterojunction radiation plane. It is confirmed that the optimum geometric thickness of the phosphor is 60˜120 μm for medium-disperse phosphor with medium linear diameter d₅₀=4±0.5 μm; to attain high optical technique parameter, the optimum thickness is L≈80 μm. The present invention also points out that the phosphor in the lighting transfer polymer is 3˜30%; the optimum value for the parameter is 12˜16%.

LED manufactures employ different polymers with different composition and degree of polymerization to make lighting conversion coating. The present invention conducts supplemental work in the selection of polymer materials. The selection criteria include the speed of polymerization, the manipulation of temperature during the polymerization process, and the viscosity of the polymer materials employed. Apart from the physical and chemical properties, the polymer should have appropriate refractive index to confirm the device's output light density. The polymer's physics-mechanics properties are also crucial, such as thermal expansion coefficient and shear stress due to temperature variation.

Further, the present invention also provides a blue-light LED (light emitting diode), which is based on InGaN semiconductor heterojunction. The heterojunction is coated with a polymer coating (not shown), in which phosphor with aforementioned composition is filled. It is characterized that the polymer coating of uniform thickness is on the main radiation surface and edge plane of the heterojunction and the concentration of the phosphor in the coating is 3˜30%,

wherein the thickness of the polymer coating is 60˜120 μm;

wherein the polymer used in the polymer coating is a thermosetting polymer containing epoxy group —C—O—C— or siloxane group —Si—O—C— with molecular mass of 10000˜25000 carbon units and 200˜500 of degree of polymerization;

wherein a lens cap based on polycarbonate for outputting light, a conical refractor, and previous polymer filled in the space between the photopolymerization films, in which the refractive index of the polymer coating is 1.45<n≦1.58, are disposed;

wherein when power is supplied, the blue-light LED will radiate warm white radiation with color temperature T≦4500K, open angle 2θ=15°, and light intensity 400 cd; for 1 W power, the lighting efficiency is over 100 lm/W and for 7 W, the lighting efficiency is over 60 lm/W.

The present invention points out that there are two thermosetting polymers can meet all the demands, wherein the first is based on epoxy resin polymer and the second is based on siloxane polymer. The epoxy resin polymer comprises epoxy group —C—O—C—, which is characterized by its high refractive index, n≈1.55, due to its oxygen atoms content. The second material contains the so-called siloxane rubber, in which the bonds of —Si—O—C— are present. These polymers are in a liquid-flowing state, and thus when a pretty large electricity power is supplied to LEDs, high mechanical stress will not be generated. The advantages of the polymers include that the light-emitting diodes will exhibit high refractive index and high optical transparency. It is characterized by that the light conversion coating is formed by polymer which is a thermosetting polymer containing epoxy group —C—O—C— or siloxane group —Si—O—C— with molecular mass of 10000˜25000 carbon units and 200˜500 of degree of polymerization.

The semiconductor heterojunction based on InGaN is installed on the crystal support (not shown), which is made from pervious sapphire Al₂O₃ or thermo-conductive crystal SiC. The front and edge planes are covered with light conversion coating of polymer, which is based on filling the phosphor according to the present invention. The coating is formed with the help of the professional micro-measurement device, from which a specific amount of drops from the polymer suspension liquid containing phosphor according to the present invention added to the heterojunction. Also, the heterojunction is assembled in a professional micro-device. The assembling work includes installing hetero-crystal of light conversion coating onto professional conical refractor (not shown), whose glass wall is usually covered with metal layer to ensure high refractive index. The refractor and the crystal within (not shown) are usually employed as the optical lens of the external lens cap (not shown) for the light-emitting diode house.

Polymer for making lighting conversion coating is injected into the space between the heterojunction plane, conical refractor, and semi-spherical lens cap to prevent light loss. A more appropriate method for the structure of the present invention is to employ organic silicon rubber, which has a refractive index of n=1.50, similar to that of polycarbonate.

The advantage exist in the light-emitting diodes and it is characterized by that to enhance the light output of light-emitting diode, a lens cap based on polycarbonate is used and the space between the lens cap, the conical refractor, and lighting conversion coating is filled with pervious polymer, which forms a coating with a refractive index of 1.45<n≦1.58.

The parameters for the devices assembled are conformed. The parameters related to current: radiation intensity 1 cd, double open angle 2θ, and light flux F (unit: lumen). Under a constant current, the heterojunction is usually connected with 20 mA, 50 mA, 100 mA, and 350 mA. A constant voltage 3.48V is supplied with the help of a voltage stabilizer. The light intensity 1 is measured in a professional light meter. The device assembled is placed in the center of the spherical light meter to obtain the total light flux. Also, a professional colorimeter is used in the spherical light meter to detect the lighting color coordinates x and y and color temperature (Kelvin temperature) in profession tables.

The results are listed in table 1.

TABLE 1

| | | | | Light | Light | | Lighting |
|---|---|---|---|---|---|---|---|
| | Forward | Forward | | flux F, | intensity, | Radiation | efficiency, |
| Device | current mA | voltage V | Power, W | lm | cd | angle, 2θ | lm/W |
| W-330 | 350 | 4.0 | 1.2 | 140 | 400 | 20 ± 5 | 95 |
| white 1 | | | | | | | |
| W-330 | 100 | 4.0 | 0.40 | 45 | 160 | 15 ± 5 | 105 |
| white 2 | | | | | | | |
| W-340 | 700 | 10.5 | 5.00 | 440 | 200 | 60 ± 10 | 92 |
| white 4 | | | | | | | |

Some important parameters for the blue-light LED are described below, which have not been disclosed elsewhere. First, the high light intensity J is 400˜600 cd, which has not been shown in the literature. The high power device is crucial for the searchlight of electric train, underground train, and so on. Second, the total light flux for the single crystal heterojunction reaches F>400 lm. Four heterojunctions are connected in a light-source series circuit to have a power of Fa=5 W. The light source can replace the storage light with Pa=50˜60 W and create directional flow (double open angle 2θ=60°). Consequently, W-340 white-4 type light-emitting diode can be used in household lighting and can provide a rather good comfort to users and create a substantial economic benefit. Finally, the light source proposed has a high lighting efficiency when the current with a wide range going through the heterojunction.

Consequently, the lighting efficiency according to the present invention can reach η=92˜105 lm/W. All the advantages can be attained in the present invention and it is characterized by that when power is supplied, the aforementioned blue-light LED can radiate warm white light with color temperature T≦4500K; when the angle 2θ=15°, the light intensity can reach 400 cd; when the power is 1 W, the lighting efficiency will be over 100 lm/W; for the overall power W=7 W, the lighting efficiency is over 90 lm/W.

Accordingly, the phosphor according to the present invention and white-light LEDs based on this phosphor have the following advantages: the phosphor prepared can have a wide radiation spectrum with its orange subband capable of producing highly effectively phosphor and when the electromagnetic wave spectrum shifts toward warm tone, the quantum efficiency does not decrease; when the temperature range is over 100° C., the thermal stability of the lighting of the phosphor increases; and higher color transmission coefficient, i.e. rendering index Ra, can be obtained. Consequently, the present invention effectively improves the drawbacks of the prior art phosphors and blue-light LEDs prepared from the prior art phosphors.

Although a particular embodiment of the invention has been described in detail for purposes of illustration, various modifications and enhancements may be made without departing from the spirit and scope of the invention.

What is claimed is:

1. A phosphor for use in the metal oxide and non-metal oxide substrate of an InGaN heterojunction coating and excitable by cerium, the phosphor being a solid solution formed of a first compound having the chemical formula of (1-x)(ΣLn)₃Al₅O₁₂ and a second compound of xMe^{II}₃Me^{III}₂Si₃O₁₂, the solid solution formed under this condition having a cubic system and 1a3d phase.

2. The phosphor as claimed in claim 1, wherein in said first compound and said second compound, Ln=Y and/or Gd and/or Lu and/or Ce and/or Yb and/or Pr and/or Sm, Me^{II}=Mg and/or Ca and/or Sr and/or Ba Me^{III}=In and/or Ga and/or Sc.

3. The phosphor as claimed in claim 1, wherein in said first compound, x=0.001˜0.15,

4. The phosphor as claimed in claim 3, wherein when Me^{II}=Mg, the lattice parameter is a≦12.0 Å; when Me^{II}≠Mg, the lattice parameter is a>12.0 Å.

5. The phosphor as claimed in claim 1, wherein said phosphor is excitable by at least two exciting agents, based on Ln=Ce and/or Yb and/or Pr and/or Sm and, in the radiation ranging from 500 to 720 nm, the maximum radiation spectrum being located at the spectrum subband, starting from λ=520˜590 nm.

6. The phosphor as claimed in claim 1, wherein said phosphor is joined to an InGaN-based semiconductor heterojunction, said InGaN-based semiconductor heterojunction offering a blue-light shortwave radiation and having the surface thereof covered by said phosphor, said phosphor being evenly distributed in the volume of a polymer coating on the surface of said InGaN-based semiconductor heterojunction.

7. The phosphor as claimed in claim 1, wherein said phosphor has a positive-ion lattice formed therein, said positive-ion lattice being based on ΣLn=Y and/or Gd and/or Lu of which the solubility in said phosphor is [Y]=3y, [Gd]=3z, and [Ln]=3p and consequently, Σ3y+3z+3p=3−x, wherein 0.6≦y≦0.79 and 0.01≦z≦0.05.

8. The phosphor as claimed in claim 1, further comprising an exiting agent based on Ce and/or Yb and/or Pr and/or Sm, the solubility of said exciting agent in the matrix of said phosphor being 0.005≦[Ce]≦0.1, 0.0001≦[Yb]≦0.001, 0.0001≦[Pr]≦0.01, and 0.0001≦[Sm]≦0.01, the maximum half-width of the radiation spectrum of said phosphor excited by said exiting agent ranging from 112˜125 nm.

9. The phosphor as claimed in claim 8, wherein the maximum half-width of the radiation spectrum starts from Δλ_{0.5}=112 nm when a pair of exciting agent, Ce+Yb, Ce+Pr, or Yb+Pr, is added, and the half width reaches Δλ=125 nm when all the sixth exciting agents of Ce+Yb+Pr+Sm are added.

10. The phosphor as claimed in claim 1, wherein when the stoichiometric coefficient x is 0.005≦x≦0.01, the light-emitting color coordinate value is Σ(x+y)≧0.8; when the stoichiometric coefficient x is 0.01≦x≦0.05, the light-emitting color coordinate value is Σ(x+y)>0.90.

11. The phosphor as claimed in claim 1, wherein said phosphor has the specific composition of Y_{2.75}Gd_{0.15}Ce_{0.019}Yb_{0.001}Mg_{0.03}Si_{0.03} and the radiation occurs in the orange spectrum of λ=575 nm with the maximum radiation spectrum λ=568 nm and the main wavelength λ=575 nm and the radiation color coordinate of x=0.41 and y=0.48.

12. The phosphor as claimed in claim 1, wherein said phosphor has the specific composition of Y_{2.96}Ce_{0.029}Pr_{0.001}Mg_{0.12}Si_{0.12}Sc_{0.04}O₁₂ and the radiation occurs in the orange spectrum of λ=574 nm with the main wavelength λ=580 nm and the radiation color coordinate of x=0.4 and y=0.51.

13. The phosphor as claimed in claim 1, wherein said phosphor has the specific composition of Y_{2.6}Gd_{0.02}Lu_{0.06}Ce_{0.019}Dy_{0.001}Ca_{0.3} and the radiation occurs in the orange spectrum of λ=576 nm with the main wavelength λ=582 nm and the radiation color coordinate of x=0.445 and y=0.538.

14. The phosphor as claimed in claim 1, wherein said phosphor has oval-shaped particles, said oval-shaped particles having a tangent diameter greater than 10˜20 times of the maximum wavelength of radiation spectrum, linear diameter in dispersion relation d₅₀=4±0.5 μm, mean diameter d_{cp}=6±0.5 μm, and diameter d₉₇≦18 μm.

15. The blue-light LED added phosphor as claimed in claim 1, then the provides a warm white radiation with color temperature T≦4500K, the lighting efficiency is over 100 lm/W.
